(19) United States
(12) Patent Application Publication
(10) Pub. No.: US 2017/0322740 A1
(43) Pub. Date: Nov. 9, 2017

(54) SELECTIVE DATA PERSISTENCE IN COMPUTING SYSTEMS

(71) Applicant: Microsoft Technology Licensing, LLC, Redmond, WA (US)

(72) Inventor: Henry Gabryjelski, Sammamish, WA (US)

(21) Appl. No.: 15/149,867

(22) Filed: May 9, 2016

(51) Int. Cl. G06F 3/06

(52) U.S. Cl. CPC G06F 3/0619; G06F 3/0685; G06F 3/0647; G06F 3/0659; G06F 3/067

(57) ABSTRACT

Embodiments of selective data persistence in computing devices and associated methods of operations are disclosed therein. In one embodiment, a method includes receiving a command to initiate persistence of data currently contained in a volatile memory module to a non-volatile memory module of a hybrid memory device. The method also includes determining whether the data in the volatile memory module is valid data. In response to determining that the data currently contained in the volatile memory module is valid data, causing the data to be copied from the volatile memory module to the non-volatile memory module. in response to determining that the data is not valid data, discarding the data currently contained in the volatile memory module.

### BACKGROUND

Servers in cloud computing datacenters can utilize non-volatile dual in-line memory modules (“NVDIMMs”) or other types of hybrid memory devices to achieve high application performance, data security, and rapid system recovery. Certain types of NVDIMMs (e.g., NVDIMM-Ns) can include a dynamic random access memory (“DRAM”) module operatively coupled to a flash memory module. The DRAM module allows fast memory access while the flash memory module can persistently retain data upon unexpected power losses, system crashes, or normal system shutdowns.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain computing systems, when a server experiences a system error, a processor of the server can instruct a corresponding memory controller to flush a buffer and write any data still in the buffer to an operatively coupled NVDIMM. The memory controller can then command the NVDIMMs to switch to self-refresh mode before the server provides a signal (e.g., a voltage signal) to an input pin (e.g., the SAVE# pin) on the NVDIMM to initiate data persistence in the NVDIMMs. In response to the provided signal, the NVDIMM can then copy and persistently store all data from the DRAM module to the corresponding flash memory module before power is removed from the NVDIMMs.

The foregoing data persistence scheme can have several drawbacks. For instance, frequent read and write operations in the flash memory module can cause the flash memory module to fail prematurely as well as consume a large amount of power. In another example, copying and persisting all data can cause a shutdown or restart process to be time consuming, and thus negatively impact user experience. In addition, data that represents encryption keys, digital rights management secrets, private health records, or other sensitive information persisted in the flash memory module can be subject to unauthorized access.

Several embodiments of the disclosed technology can address at least some of the foregoing drawbacks by selectively persisting data in NVDIMMs or other types of hybrid memory devices. The NVDIMMs can include a DRAM module, a flash memory module, and a module controller operatively coupled to one another. In certain embodiments, the module controller can track any write operations to the DRAM module or to individual memory blocks or memory ranges in the DRAM module. Upon receiving a command to initiate data persistence, the module controller can determine whether any write operation has been performed to the DRAM module or memory blocks thereof. In response to determining that no write operation have been performed to the DRAM module or memory blocks thereof, the module controller can omit persisting data from the DRAM module or memory blocks thereof.

In other embodiments, a computing system can attach certain policies as, for example, metadata to data of sensitive information to be written to the DRAM module. For example, the policies can include restrictions to locations the data should be placed in the DRAM module (e.g., in a separate block from all other data, from certain data, in a head block, in a tail block, etc.). The policies can also indicate to the module controller that the data of sensitive information is not to be persisted irrespective of any prior write operations. In response, even if the module controller determines that the DRAM module or memory blocks thereof containing the data has been written to, the module controller can omit persisting the data of sensitive information.

In further embodiments, upon receiving the instruction to initiate data persistence, the module controller can cause data to be read out for example, by a processor, from both the DRAM module and the flash memory module to, for example, a main memory. The processor can then compare the read out data from the DRAM module with those from the flash memory module. In response to determining that the data from the DRAM module is not different (or not substantially different) from the data from the flash memory module, the module controller can omit persisting the data from the DRAM module or memory blocks thereof.

Several embodiments of the disclosed technology can reduce the number of write operations performed in the flash memory module by not persisting certain data from the DRAM module to the flash memory module. As such, NVDIMMs configured in accordance with several embodiments of the disclosed technology can have lower power consumption and longer useable life than conventional devices. Several embodiments of the disclosed technology can also improve data security. By designating certain data of sensitive information to be non-persisted in the DRAM or memory blocks thereof, the computing system can safeguard sensitive information during shutdowns, restarts, or other suitable operations.

### BRIEF DESCRIPTION OF THE DRAWINGS

FIG. 1 is a schematic block diagram illustrating a computing system having computing units with selective data persistence configured in accordance with embodiments of the present technology.

FIGS. 2A-2D are schematic block diagrams of a computing unit suitable for the computing system of FIG. 1 at various operational stages in accordance with embodiments of the present technology.

FIG. 3 is a schematic block diagram of another computing unit suitable for the computing system of FIG. 1 at an operational stage in accordance with embodiments of the present technology.

FIGS. 4A-4C are schematic block diagrams of another computing unit suitable for the computing system of FIG. 1 at various operational stages in accordance with embodiments of the present technology.

FIG. 5 is a block diagram showing software modules suitable for the module controller of FIGS. 2A-4C in accordance with embodiments of the present technology.

FIG. 6A is a flow diagram illustrating a process for selective data persistence in accordance with embodiments of the present technology.

FIGS. 6B-6D are flow diagrams illustrating a process for analyzing data in an hybrid memory devices in accordance with embodiments of the present technology.

FIG. 7 illustrates one example of utilizing multiple tracking bits for tracking write operations in a volatile memory module of a hybrid memory device in accordance with embodiments of the present technology.

### DETAILED DESCRIPTION

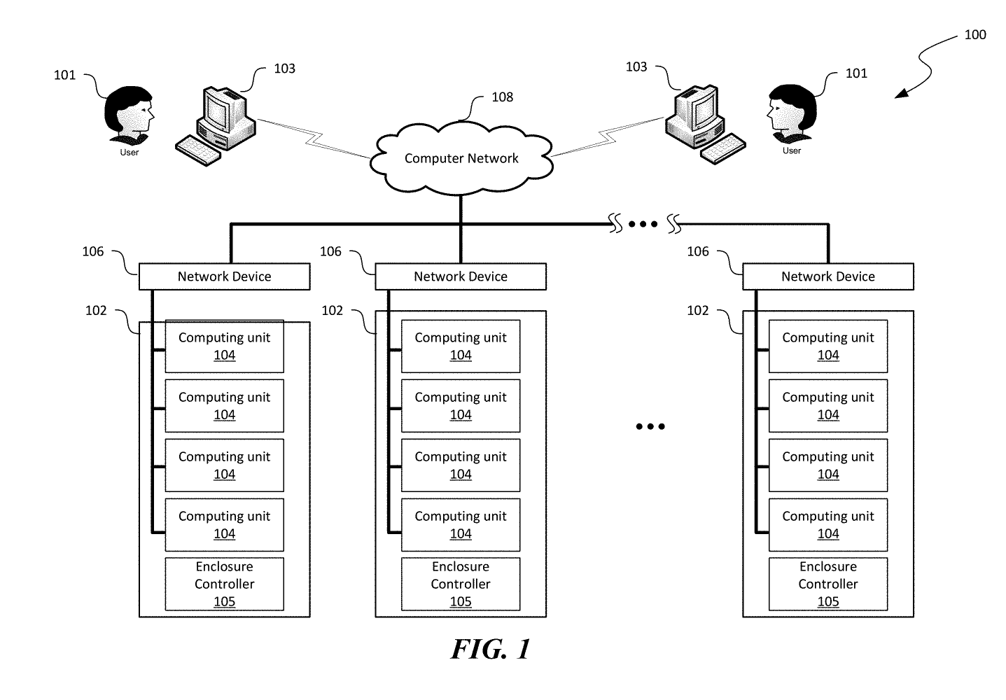

Various embodiments of computing systems, devices, components, modules, routines, and processes related to selective data persistence in hybrid memory devices are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-6D.

As used herein, the term “volatile memory” generally refers to a computer memory that requires power to maintain stored data. One example volatile memory is DRAM, which can retain stored data when powered via refreshing. When power is removed or interrupted, DRAM modules can lose stored data quickly (e.g., within minutes) due to a lack of refreshing. In contrast, the term “non-volatile memory” generally refers to a computer memory that can retain stored data even without power. Examples of non-volatile memory include read-only memory (“ROM”), flash memory (e.g., NAND or NOR solid state drives), and magnetic storage devices (e.g. hard disk drives).

Also used herein, the term “hybrid memory device” generally refers to a computer memory device that includes one or more volatile memory modules and non-volatile memory modules operatively coupled to one another. In certain implementations, the hybrid memory device can have an external data bus and corresponding logic to be configured as a randomly addressable memory (“RAM”) module. Example RAM modules include DIMMs (Dual Inline Memory Modules), JEDEC (Joint Electron Device Engineering Council) DDR SDRAM, and modules configured according to other suitable RAM specifications. The one or more non-volatile memory devices can be primarily or exclusively used to facilitate or ensure that certain data in the volatile memory modules appears to be persistent. As such, data in the volatile memory modules can be persisted when power is unexpectedly interrupted during operation or during normal shutdowns.

One example hybrid memory device is a type of NVDIMM (e.g., NVDIMM-N). In at least some implementations, an NVDIMM can include both DRAM and flash memory operatively coupled to one another. NVDIMMs can also include a module controller configured to manage operations of the DRAM, the flash memory, and operations between the DRAM and the flash memory. In some implementations, an NVDIMM can also include and use a capacitor as an auxiliary power source for data persistence when a primary power source is unavailable. In other implantations, the auxiliary power source can be external to the NVDIMM. Even though the description herein uses NVDIMM as an example hybrid memory device, embodiments of the disclosed technology can also be implemented other suitable types of hybrid memory devices.

In certain computing systems, hybrid memory devices (e.g., NVDIMMs) are used for data storage due to a combination of fast data access times of volatile memory (e.g., DRAM) and the high data reliability, high data availability, and low system crash recovery time of fully non-volatile memory. Hybrid memory devices can include DRAM modules for fast access and flash memory modules for persistently store data from the DRAM modules. However, recurrent persistence of all data from DRAM modules to flash memory modules can result in high power consumption, shortened useful life of the flash memory modules, or a high risk of security breaches.

Several embodiments of the disclosed technology can address at least some of the foregoing drawbacks by selectively persisting data from DRAM modules to flash memory modules in hybrid memory devices. Various conditions or criteria can be utilized to select what data is to be persisted. In certain embodiments, data in a DRAM module can be persisted in response to determining that the data has been modified, e.g., written to by a memory controller. In other embodiments, data in the DRAM module can also be compared to data preexisting in a flash memory module. In response to determining that the data in the DRAM module is different than that in the flash memory module, the data in the DRAM module can be persisted; otherwise, the data in the DRAM module can be discarded as redundant or invalid data. Additional examples and embodiments of the disclosed technology are described in more detail below with reference to FIGS. 1-6D.

FIG. 1 is a schematic block diagram illustrating a computing system 100 having computing units with selective data persistence configured in accordance with embodiments of the present technology. As shown in FIG. 1, the computing system 100 can include multiple computer enclosures 102 individually housing computing units 104 interconnected by a computer network 108 via network devices 106. The computer network 108 can also be configured to interconnect the individual computing units 104 with one or more client devices 103. Even though particular configurations of the computing system 100 are shown in FIG. 1, in other embodiments, the computing system 100 can also include additional and/or different components than those shown in FIG. 1.

The computer enclosures 102 can include structures with suitable shapes and sizes to house the computing units 104. For example, the computer enclosures 102 can include racks, drawers, containers, cabinets, and/or other suitable assemblies. In the illustrated embodiment of FIG. 1, four computing units 104 are shown in each computer enclosure 102 for illustration purposes. In other embodiments, individual computer enclosures 102 can also include ten, twenty, or any other suitable number of computing units 104. In further embodiments, the individual computer enclosures 102 can also include power distribution units, fans, intercoolers, and/or other suitable electrical and/or mechanical components (not shown).

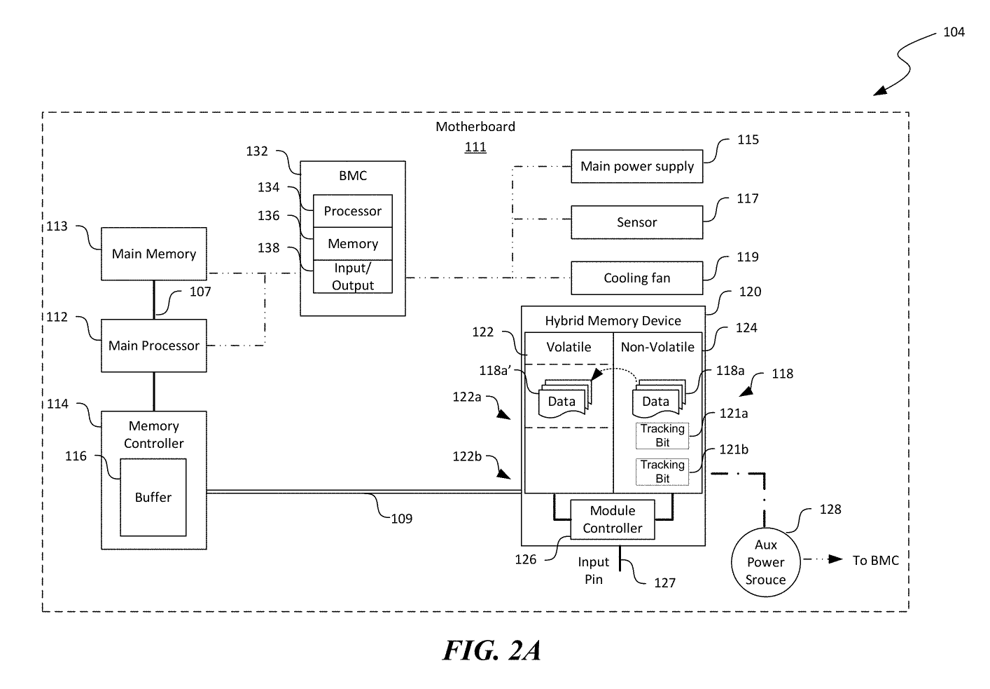

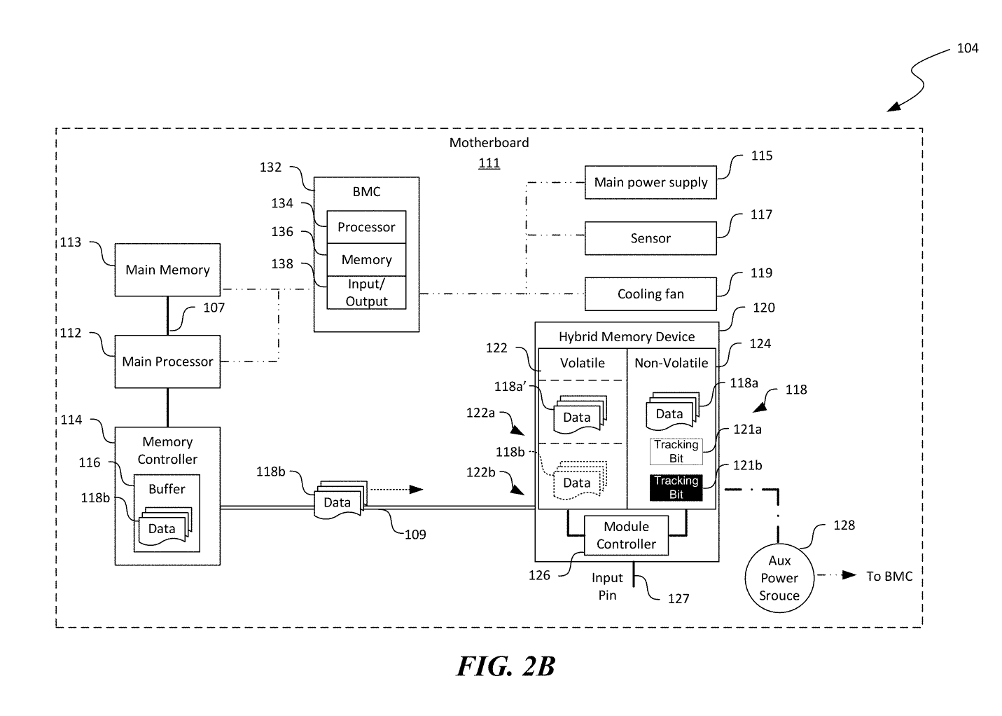

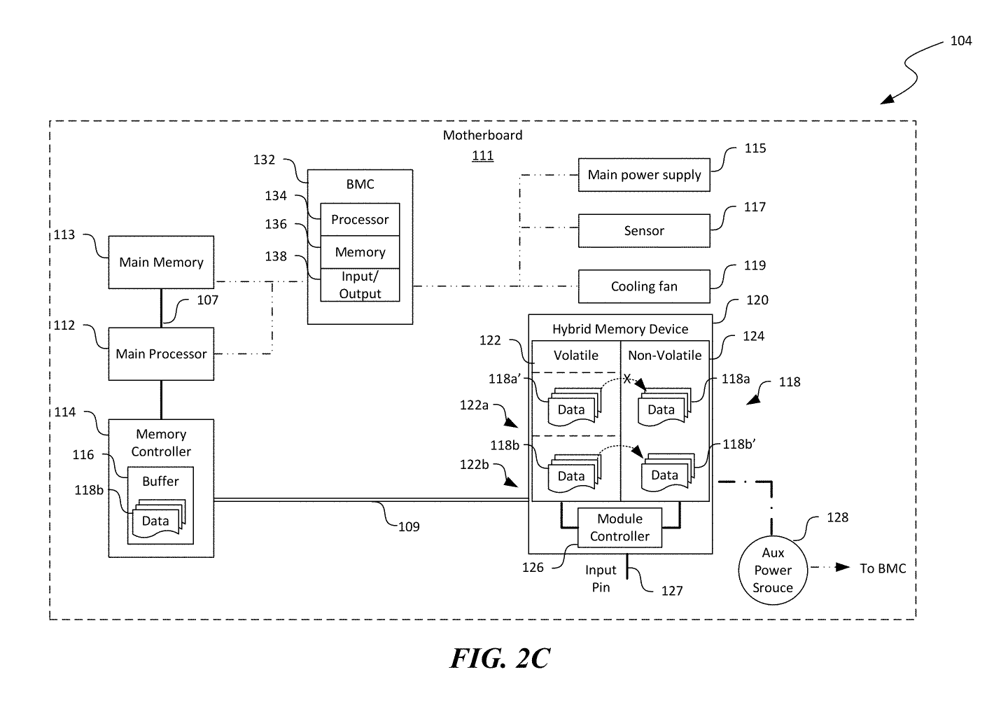

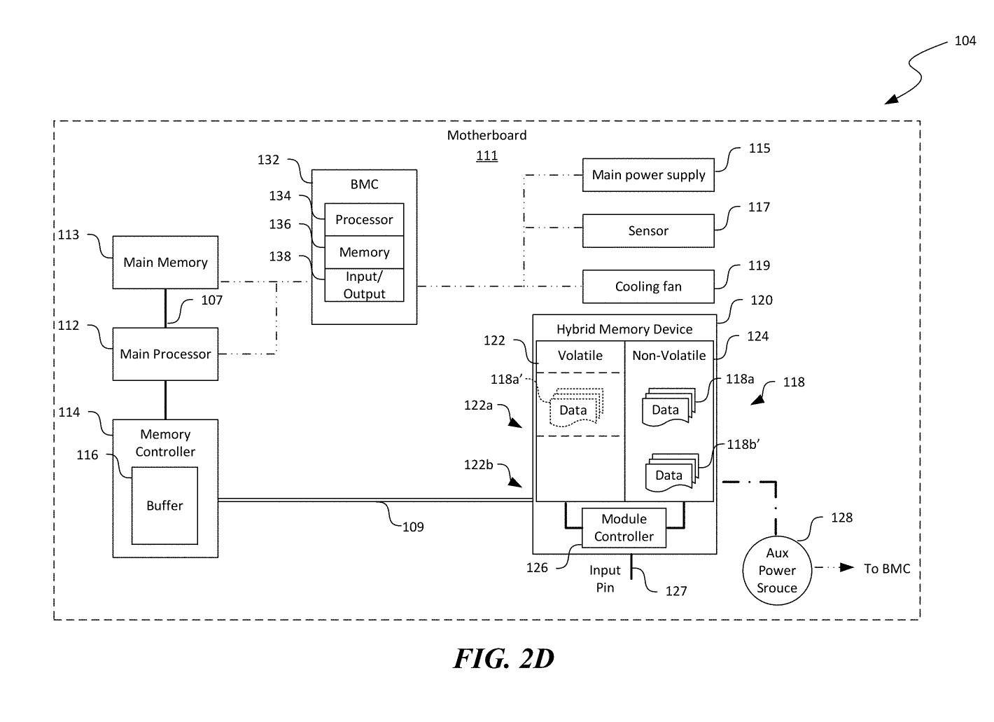

The computing units 104 can individually include one or more servers, network storage devices, network communications devices, or other suitable computing devices suitable for datacenters or other computing facilities. In certain embodiments, the computing units 104 can be configured to implement one or more cloud computing applications and/or services accessible by user 101 using the client device 103 (e.g., a desktop computer, a smartphone, etc.) via the computer network 108. The computing units 104 can individually include one or more hybrid memory devices 120 (shown in FIGS. 2A-4C) and can be configured to implement selective data persistence in accordance with embodiments of the disclosed technology, as described in more detail below with reference to FIGS. 2A-4C.

As shown in FIG. 1, the individual computer enclosures 102 can also include an enclosure controller 105 configured to monitor and/or control a device operation of the computing units 104, power distribution units, fans, intercoolers, and/or other suitable electrical and/or mechanical components. For example, the enclosure controllers 105 can power up, power down, reset, power cycle, refresh, and/or perform other suitable device operations on a particular computing unit 104 in a computer enclosure 102. In certain embodiments, the individual enclosure controllers 105 can include a rack controller configured to monitor operational status of the computing units 104 housed in a rack. One suitable rack controller is the Smart Rack Controller (EMX) provided by Raritan of Somerset, N.J. In other embodiments, the individual enclosure controllers 105 can include a cabinet controller, a container controller, or other suitable types of controller.

In the illustrated embodiment, the enclosure controllers 105 individually include a standalone server or other suitable types of computing device located in a corresponding computer enclosure 102. In other embodiments, the enclosure controllers 105 can include a service of an operating system or application running on one or more of the computing units 104 in the individual computer enclosures 102. In further embodiments, the in the individual computer enclosures 102 can also include remote server coupled to the computing units 104 via an external network (not shown) and/or the computer network 108.

In certain embodiments, the computer network 108 can include twisted pair, coaxial, untwisted pair, optic fiber, and/or other suitable hardwire communication media, routers, switches, and/or other suitable network devices. In other embodiments, the computer network 108 can also include a wireless communication medium. In further embodiments, the computer network 108 can include a combination of hardwire and wireless communication media. The computer network 108 can operate according to Ethernet, token ring, asynchronous transfer mode, and/or other suitable link layer protocols. In the illustrated embodiment, the computing units 104 in the individual computer enclosure 102 are coupled to the computer network 108 via the network devices 106 (e.g., a top-of-rack switch) individually associated with one of the computer enclosures 102. In other embodiments, the computer network 108 may include other suitable topologies, devices, components, and/or arrangements.

In operation, the computing units 104 can receive requests from the users 101 using the client device 103 via the computer network 108. For example, the user 101 can request a web search using the client device 103. After receiving the request, one or more of the computing units 104 can perform the requested web search and generate relevant search results. The computing units 104 can then transmit the generated search results as network data to the client devices 103 via the computer network 108 and/or other external networks (e.g., the Internet, not shown).

As described in more detail below with reference to FIGS. 2A-4C, the individual computing units 104 can include one or more hybrid memory devices 120, and can implement selective data persistence in accordance with embodiments of the disclosed technology. The implemented selective data persistence can at least reduce, or even eliminate recurrent persistence of all data from DRAM modules to flash memory modules in the hybrid memory devices 120. As a result, power consumption of the computing units 104 and risks of security breaches can be reduced while useful life of the hybrid memory devices 120 can be lengthened.

FIGS. 2A-2D are schematic block diagrams of a computing unit 104 suitable for the computing system 100 in FIG. 1 at various operational stages in accordance with embodiments of the disclosed technology. In particular, FIG. 2A shows the computing unit 104 during a startup stage such as a warm boot or a cold boot. FIG. 2B shows the computing unit 104 during a write operation to a hybrid memory device. FIG. 2C shows the computing unit 104 during a selective data persistence operation in the hybrid memory device. FIG. 2D shows the computing unit 104 subsequent to power removal from the computing unit 104. Details of the various operational stages are described below in turn.

As shown in FIG. 2A, the computing unit 104 can include a motherboard 111 carrying a main processor 112, a main memory 113, a hybrid memory device 120, an auxiliary power source 128, and a baseboard management controller (“BMC”) 132 operatively coupled to one another. The motherboard 111 can also carry a main power supply 115, a sensor 117 (e.g., a temperature or humidity sensor), and a cooling fan 119 (collectively referred to as “peripheral devices”) coupled to the BMC 132. Though FIGS. 2A-2D only show the motherboard 111 in phantom lines, the motherboard 111 can include a printed circuit board with one or more sockets configured to receive the foregoing or other suitable components described herein. In other embodiments, the motherboard 111 can also carry computer storage devices (e.g., a hard disk drive), indicators (e.g., light emitting diodes), communication components (e.g., a network interface module), platform controller hubs, complex programmable logic devices, and/or other suitable mechanical and/or electric components in lieu of or in addition to the components shown in FIGS. 2A-2D.

In further embodiments, the motherboard 111 can be configured as a computer assembly or subassembly having only portions of those components shown in FIGS. 2A-2D. For example, the motherboard 111 can form a computer assembly containing only the main processor 112, main memory 113, and the BMC 132 without the hybrid memory device 120 being received in a corresponding socket. In other embodiments, the motherboard 111 can also be configured as another computer assembly with only the BMC 132. In further embodiments, the motherboard 111 can be configured as other suitable types of computer assembly with suitable components.

The main processor 112 can be configured to execute instructions of one or more computer programs by performing arithmetic, logical, control, and/or input/output operations, for example, in response to a user request received from the client device 103 (FIG. 1). The main processor 112 can include one or more microprocessors, field-programmable gate arrays, and/or other suitable logic devices. Even though only one main processor 112 is shown in FIG. 2A, in other embodiments, the computing unit 104 can include two, three, or any suitable number of main processors (not shown) operating in parallel, serial, or in other suitable fashions.

As shown in FIG. 2A, the main processor 112 can be coupled to a memory controller 114 having a buffer 116. The memory controller 114 can include a digital circuit that is configured to monitor and manage operations of the hybrid memory device 120. For example, in one embodiment, the memory controller 114 can be configured to periodically refresh the hybrid memory device 120. In another example, the memory controller 114 can also continuously, periodically, or in other suitable manners transmit or “write” data 118b (shown in FIG. 2B) in the buffer 116 to the hybrid memory device 120. In the illustrated embodiment, the memory controller 114 is separate from the main processor 112. In other embodiments, the memory controller 114 can also include a digital circuit or chip integrated into the main processor 112. One example memory controller is the Intel® 5100 memory controller provided by the Intel Corporation of Santa Clara, Calif.

The main memory 113 can include a digital storage circuit directly accessible by the main processor 112 via, for example, a memory bus 107. The main processor 112 can continuously read instructions and/or data stored in the main memory 113 and executes the instructions as commanded. Any data actively operated on by the main processor 112 can also be stored in the main memory 113. In certain embodiments, the main memory 113 can include one or more DRAM modules. In other embodiments, the main memory 113 can also include magnetic core memory or other suitable types of memory. Even though the main memory 113 is shown as a separate component from the hybrid memory device 120 in FIG. 2A, in certain embodiments, the hybrid memory device 120 can also be a part of the main memory 113. As such, the main processor 112 can read instructions and/or data stored in as well as writing data to the hybrid memory device 120. In other embodiments, the main memory 113 can be omitted from the computing unit 104, and the hybrid memory device 120 can be the primary memory component accessible to the main processor 112.

The BMC 132 can be configured to monitor operating conditions and control device operations of various components on the motherboard 111. As shown in FIG. 2A, the BMC 132 can include a processor 134, a memory 136, and an input/output component 138 operatively coupled to one another. The processor 134 can include one or more microprocessors, field-programmable gate arrays, and/or other suitable logic devices. The memory 136 can include volatile and/or nonvolatile computer readable media (e.g., ROM, RAM, magnetic disk storage media, optical storage media, flash memory devices, EEPROM, and/or other suitable non-transitory storage media) configured to store data received from, as well as instructions for, the processor 136. In one embodiment, both the data and instructions are stored in one computer readable medium. In other embodiments, the data may be stored in one medium (e.g., RAM), and the instructions may be stored in a different medium (e.g., EEPROM). The input/output component 124 can include a digital and/or analog input/output interface configured to accept input from and/or provide output to other components of the BMC 132. One example BMC is the Pilot 3 controller provided by Avago Technologies of Irvine, Calif.

As shown in FIG. 2A, the hybrid memory device 120 can include a volatile memory module 122, a non-volatile memory module 124, and a module controller 126 operatively coupled to one another. The non-volatile memory module 124 can include one or more flash memory modules, static random access modules, optical storage devices, magnetic storage devices, or other suitable non-volatile memory components. The non-volatile memory module 122 can persistently store data even when power is removed from the hybrid memory device 120. As shown in FIG. 2A, the non-volatile memory module 124 can contain first data 118a that can be retrieved and copied to the volatile memory module 122 during, for example, a warm boot, cold boot, or other suitable operations.

The volatile memory module 122 can include one or more DRAM modules or other suitable types of volatile memory components. In certain embodiments, memory spaces in the volatile memory module 122 can be physically and/or logically divided into multiple zones, blocks, ranges, pages, or other suitable divisions. For example, as shown in FIG. 2A, the volatile memory module 122 is divided into a first memory block 122a and a separate second memory block 122b. The first data 118a′ copied from the non-volatile memory module 124 is stored in the first memory block 122a. In other embodiments, the volatile memory module 122 can also be considered as a single memory block. In further embodiments, the volatile memory module 122 can be divided into three, four, eight, sixteen, or other suitable numbers of blocks of, for instance, 64K bytes, 128K bytes, 256K bytes, or of other suitable memory sizes.

The module controller 126 can be configured to monitor and manage operations of the volatile and non-volatile memory modules 122 and 124 as well as interoperation therebetween. For example, the module controller 126 can be configured to monitor read, write, erase, or other suitable operations performed in the volatile memory module 122 and/or the non-volatile memory module 124. The module controller 126 can be configured to selectively persist data from the volatile memory module 122 to the non-volatile memory module 124, as described in more detail below with reference to FIGS. 2B-2D.

In certain embodiments, the hybrid memory device 120 can include an input pin 127 (e.g., the SAVE# pin) configured to receive an input signal from the BMC 132 for initiating data backup from the volatile memory module 122 to the non-volatile memory module 124. The input signal can include a voltage signal, a current signal, or other suitable types of signal. In response to a received input signal, the module controller 126 can cause selective persistence of any data 118 from the volatile memory module 122 to the non-volatile memory module 124, as described in more detail below. In other embodiments, the hybrid memory device 120 can also include other suitable types of computer readable storage devices.

The auxiliary power source 128 can be configured to controllably provide an alternative power source (e.g., 12-volt DC) to the hybrid memory device 120 in lieu of the main power supply 115 of the computing unit 104. In the illustrative embodiment, the auxiliary power source 128 includes a power supply that is separate from the main power supply 115. In other embodiments, the auxiliary power source 128 can also be an integral part of the main power supply 115. In further embodiments, the auxiliary power source 128 can be an integral part of the hybrid memory device 120 and include a capacitor sized to contain sufficient power to write all data from the volatile memory 122 to the non-volatile memory 124. As shown in FIG. 2A, the BMC 132 can monitor and control operations of the auxiliary power source 128, as described in more detail below.

The peripheral devices can provide input to as well as receive instructions from the BMC 132 via the input/output component 138. For example, the main power supply 115 can provide power status, running time, wattage, and/or other suitable information to the BMC 132. In response, the BMC 132 can provide instructions to the main power supply 115 to power up, power down, reset, power cycle, refresh, and/or other suitable power operations. In another example, the cooling fan 119 can provide fan status to the BMC 132 and accept instructions to start, stop, speed up, slow down, and/or other suitable fan operations based on, for example, a temperature reading from the sensor 117. In further embodiments, the motherboard 111 may include additional and/or different peripheral devices.

As shown in FIG. 2A, the computing unit 104 can include a data bus 109 that interconnects the main processor 112 and the hybrid memory device 120. In one embodiment, the data bus 109 can include an inter-integrated circuit bus or I²C bus as detailed by NXP Semiconductors N.V. of Eindhoven, the Netherlands. In other embodiments, the data bus 109 can also include a system management bus, RS-232, small computer system interface bus, or other suitable types of control and/or communications bus.

FIG. 2A shows an operating stage in which at least some data persistently stored in the non-volatile memory module 124 is coped to the volatile memory module 122 during a warm boot, a cold boot, or other suitable operation. In the illustrated embodiment, a copy of first data 118a from the non-volatile memory module 124 is copied into the first memory block 122a of the volatile memory module 122 to be accessed (e.g., read) by the main processor 112.

In accordance with embodiments of the disclosed technology, the module controller 126 can monitor and track changes of any data contained in the volatile memory module 122. For instance, the module controller 126 can use a single bit to indicate whether data in the volatile memory module 122 (or any subdivisions thereof) has been changed by the memory controller 114 and/or the main processor 112. In the illustrated example in FIG. 2A, the module controller 126 can set a tracking bit 121a to a value of “0” indicate that the first data 118a′ has not been changed because the first data 118a′ is merely a copy of the first data 118a in the non-volatile memory module 124. In other embodiments, the module controller 126 can track changes to any data in the volatile memory module 122 using a byte, a string, or other suitable data structures.

Once booted up, the main processor 112 can receive requested tasks from the client devices 103 (FIG. 1) via the computer network 108 (FIG. 1). The main processor 112 can then perform the requested tasks and route generated results as network data to the client devices 103. As shown in FIG. 2B, during processing, the main processor 112 can write second data 118b in the buffer 116 of the memory controller 114 to the volatile memory module 122 of the hybrid memory device 120. Because the volatile memory module 122 can provide fast data access, the main processor 112 and/or the memory controller 114 can rapidly write and store the second data 118b in the volatile memory module 122.

In the illustrated embodiment in FIG. 2B, a copy of the second data 118b (shown in phantom lines for clarity) is written into the second memory block 122b of the volatile memory module 122. In response to the received second data 118b in the second memory block 122b, the module controller 126 can track such write operations and indicate that data contained in the second memory block 122b has been changed by setting, for instance, a tracking bit 121b to a value of “1” (shown in reverse contrast for clarity). In certain embodiments, the module controller 126 can reset the tracking bit 121b to “0” subsequent to a reboot of the computing unit 104. In other embodiments, the module controller 126 can reset the tracking bit 121b based on instructions from the main processor 112 or other suitable inputs. Even though the tracking bits 121a and 121b are shown in FIGS. 2A and 2B as being held in the non-volatile memory module 124 of the hybrid memory device 120, in other embodiments, the tracking bits 121a and 121b can also be held in the memory 136 of the BMC 132, a network storage location, or other suitable locations.

FIG. 2C shows another operating stage in which the module controller 126 selectively persists certain data contained in the volatile memory module 122 to the non-volatile memory module 124 in response to a signal from the BMC 132 on the input pin 127 or an instruction from the memory controller 114. Various conditions can trigger such selective persistence operations in the hybrid memory device 120. For example, in certain embodiments, the computing unit 104 can experience a power failure, a system fault, or other abnormal operating conditions. In other embodiments, the computing unit 104 can be instructed to initiate a normal shutdown operation by the enclosure controller 105 (FIG. 1). In further embodiments, the computing unit 104 can be configured to periodically initiate selective data persistence.

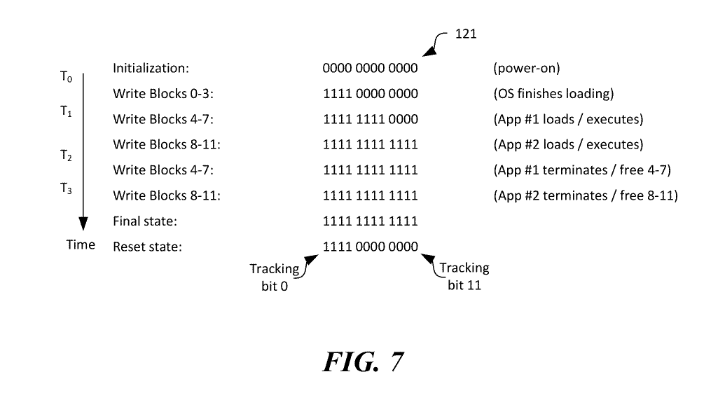

As shown in FIG. 2C, the module controller 126 can be configured to determine what data to persist based on whether the data has been changed during prior operations. For example, in the illustrated embodiment, the first data 118a′ has not been changed because the first memory block 122a has not been written to. As such, the module controller 126 can indicate not to persist the first data 118a′ from the volatile memory module 122 to the non-volatile memory module 124 because the tracking bit 121a (FIG. 2B) corresponding to the first memory block 122a has a value of “0.” In contrast, the module controller 126 can cause persistence of the second data 118b because the second memory block 122b has been written into and the tracking bit 121b (FIG. 2B) corresponding to the second memory block 122b has a value of “1.” One example of utilizing multiple tracking bits for tracking write operations in the volatile memory module 122 is described in more detail below with reference to FIG. 7.

During persistence, the module controller 126 can indicate to the BMC 134 that power from the auxiliary power source 128 is needed in the event that the main power supply 115 is lost. Once the persistence operation is completed, the module controller 126 can indicate to the BMC 132 that power from the auxiliary power source 128 can be removed. FIG. 2D shows the computing system 100 after a shutdown, a power failure, or under other conditions in which all power is removed from the hybrid memory device 120. As shown in FIG. 2D, the non-volatile memory module 124 can contain and persistently store the first data 118a and the second data 118b′ copied from the second memory block 122b of the volatile memory module 122. Unlike in other computing systems in which all data from the volatile memory module 122 is copied and persisted in the non-volatile memory module 124, in the example discussed above, only the second data 118b′ is copied and persisted, not the first data 118a′ (shown in phantom lines for clarity). As such, a number of write operations on the non-volatile memory module 124 can be reduced to lengthen a usable life of the non-volatile memory module 124.

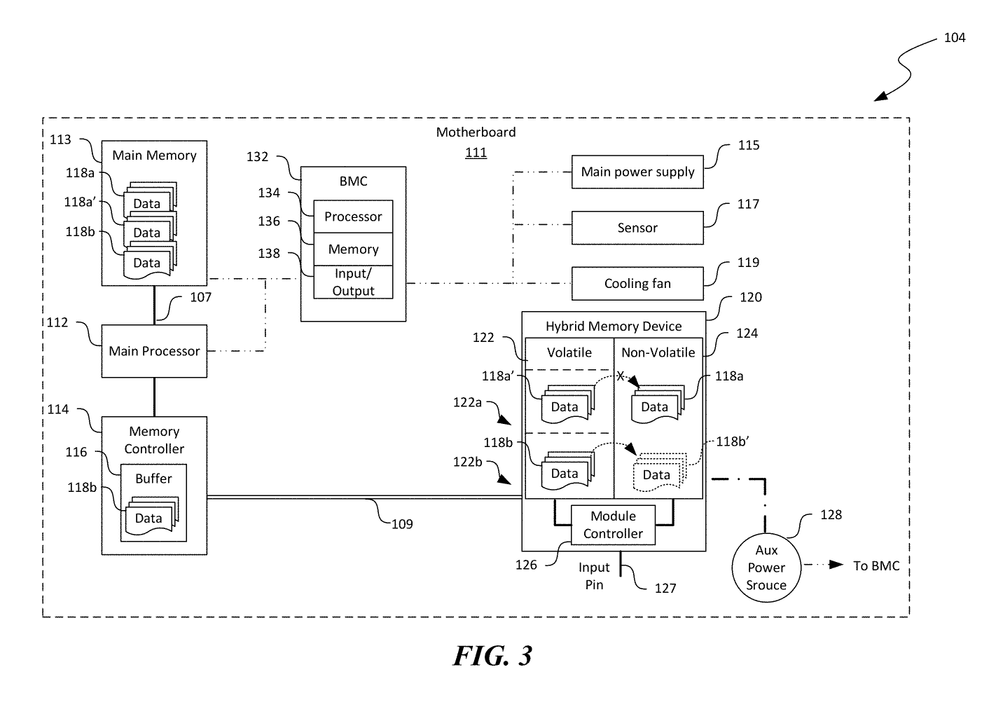

In the example described above, the module controller 126 is configured to determine whether data in the volatile memory module 122 is to be copied and persisted in the non-volatile memory module 124 based on data change tracking. In other embodiments, the module controller 126 can also generate the determination based on other suitable conditions. For example, as shown in FIG. 3, in response to a signal or instruction to initiate a selective persistence operation, the module controller 126 can be configured to cause all data in the volatile memory module 122 and the non-volatile memory module 124 be read out to, for instance, the main memory 113.

The module controller 126 can then cause the main processor 112 to compare the read out data to determine whether identical or at least substantially similar data exists. Bitwise, byte-wise, or other suitable comparison techniques can be used to comparing the data. As shown in FIG. 3, based on the comparison, the main processor 113 can determine that the first data 118a′ from the volatile memory module 122 is the same or at least substantially similar (e.g., greater than 98%, or 99% the same) to the first data 118a from the non-volatile memory module 124. The main processor 113 can also determine that no similar second data 118b exists in the non-volatile memory module 124. The main processor 112 can then transmit the comparison results (not shown) to the module controller 126. In response, the module controller 126 can cause copying and persistence of the second data 118b from the volatile memory module 122 to the non-volatile memory module 124 but not the first data 118a′.

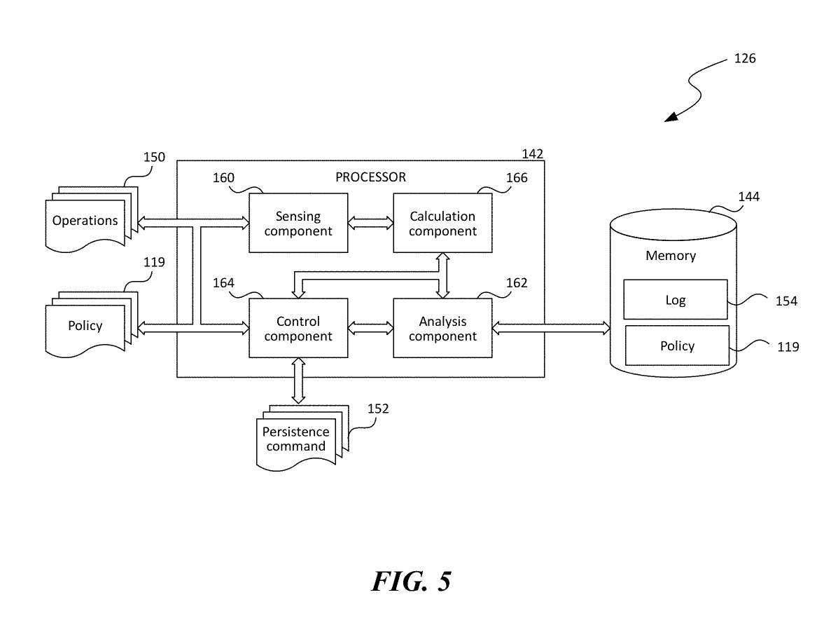

In other embodiments, the module controller 126 can perform the foregoing data comparison with little or no reliance on the main processor 112 or the main memory 113. For example, in certain embodiments, upon assertion of the SAVE# signal 127, the module controller 126 can at least partially disconnect the hybrid memory device 120 from the memory controller 114 such that no further updates or writes to any data can occur during data persistence. Subsequently, the module controller 126 can utilize a low-power processor (not shown) or a processor 142 (shown in FIG. 5) of the module controller 126 to perform data comparison for the first and second memory blocks 122a and 122b. In response to determining that a data comparison does match for the first memory block 122a, the module controller 126 can skip persisting the first data 118a′ from the volatile memory module 122 to the non-volatile memory module 124. On the other hand, in response to determining that a data comparison does not match for the second memory block 122b, the module controller 126 can cause the second data 118b to be copied and persisted in the non-volatile memory module 124. If additional memory blocks exist, the module controller 126 can repeat the foregoing operations for all the additional memory blocks. In further embodiments, the BMC 132 can assert the SAVE# signal 127 and cause connectivity to the hybrid memory device 120 be selectively switched to the BMC 132. The BMC 132 can then perform the data comparison described above and returns control to the memory controller 126 upon completion of data persistence.

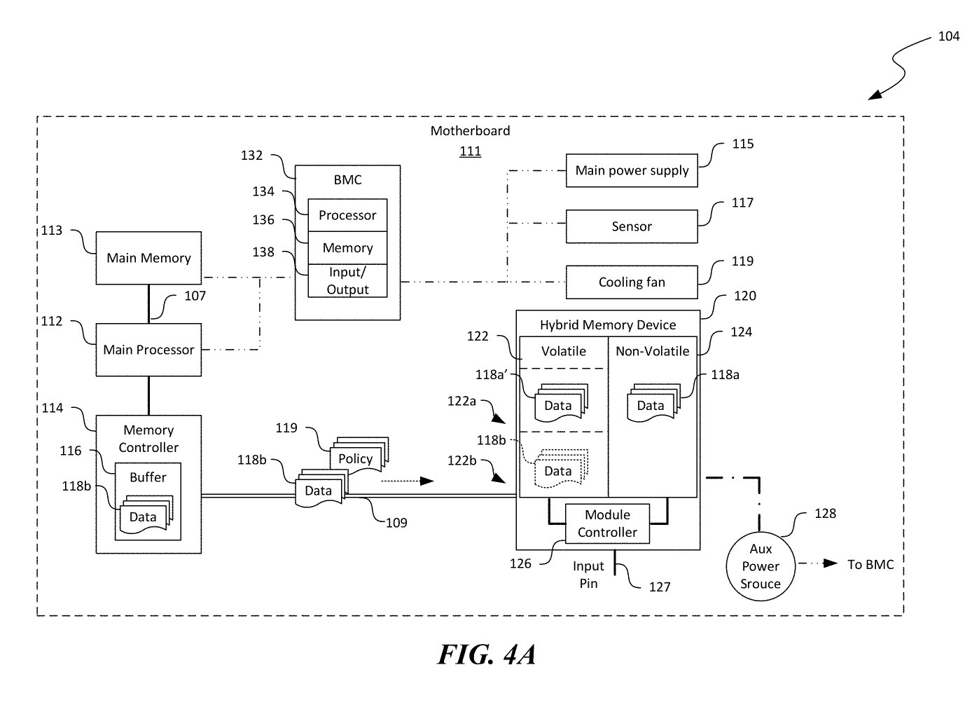

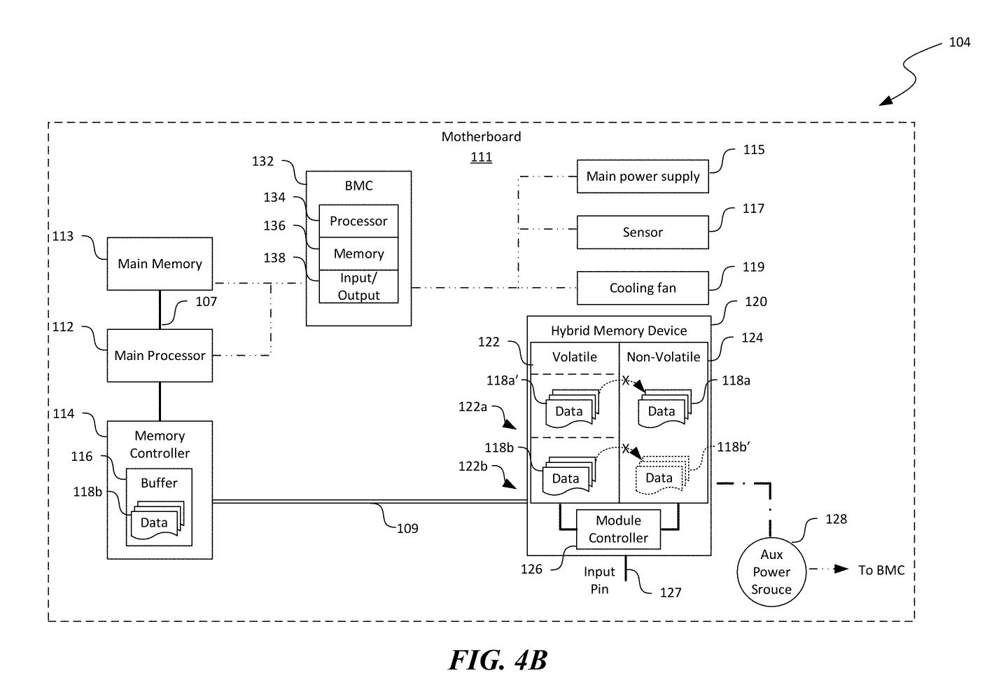

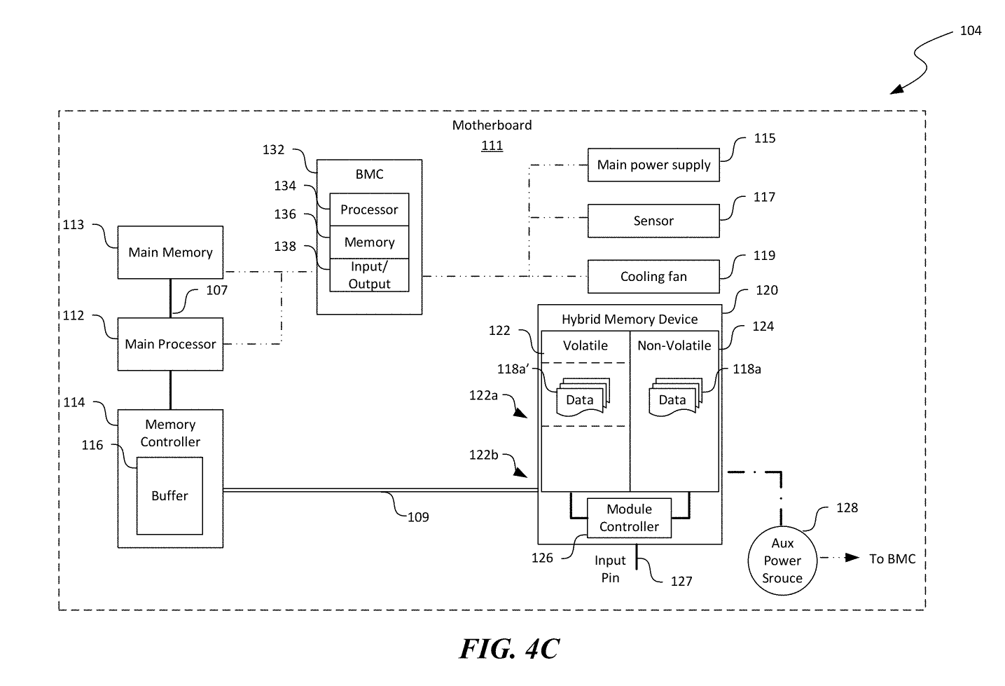

In further embodiments, the module controller 126 can also determine whether to copy and persist certain data from the volatile memory module 122 to the non-volatile memory module 124 based on indications from the memory controller 114. For example, as shown in FIG. 4A, the memory controller 114 can write a copy of the second data 118b to the second memory block 122b of the volatile memory module 122 along with certain metadata containing one or more policies 119. In one example, the policies 119 can indicate to the module controller 126 that the second data 118b must be written into a memory block separate from all other memory blocks in the volatile memory module 122 that already contain data. In response, as shown in FIG. 4A, the copy of the second data 118b is written into the second memory block 122b separate from the first memory block 122a which already contains the first data 118a′. In another example, the policies 119 can indicate to the module controller 126 that the second data 118b is to be written to a predetermined memory location (e.g., an address in the volatile memory module 122). In certain implementations, the predetermined memory location conclusively determines a corresponding memory block for the second data 118b. In other implementations, the corresponding memory block can be determined based on the predetermined memory location and other suitable information. The policies 119 can also indicate to the module controller 126 that the second data 118b shall not be written to the corresponding memory block prior to the module controller 126 validating the policy 119 for the corresponding memory block 122. In yet another example, the policies 119 can indicate to the module controller 126 that valid data in the volatile memory 122 (e.g., the second data 118b in the second memory block 122b) shall be further encrypted prior to persistence in the non-volatile memory module 124.

In another example, second data 118b can contain encryption keys, digital rights management secrets, private health records, other sensitive information, or other information that the computing unit 104 deems to be inappropriate for persisting. As such, the policies 119 can include a bit that indicates to the module controller 126 that the second data 118b is not to be persisted irrespective of whether the second data 118b has been modified. In response, as shown in FIG. 4B, the module controller 126 can skip persisting the second data 118b during a selective data persistence operation. In further examples, in addition to not being persisted, the policies 119 can also indicate to the module controller 126 that the second data 118b can have a lifespan of 5 seconds, 10 seconds, or other suitable time period. In response to such policies 119, the module controller 126 can track a life of the second data 118b and automatically erase the second data 118b from the volatile memory module 122 when the lifespan is reached, as shown in FIG. 4C.

Even though selective data persistence is described above based on particular example conditions or, in other embodiments, the module controller 126 can determine what data to persist based on other suitable conditions or criteria. For example, in certain embodiments, the module controller 126 can recognize a data pattern of any data contained in the volatile memory module 122 and compare the data pattern to preset patterns. The module controller 126 can then determine whether to persist certain data based on the comparison results, as described in more detail below with reference to FIG. 5.

FIG. 5 is a block diagram showing certain computing system components suitable for the module controller 126 in FIGS. 2A-4C in accordance with embodiments of the disclosed technology. In FIG. 5 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 5, the module controller 126 can include a processor 142 operatively coupled to a memory 144. The processor 142 and the memory 144 can be generally similar in structure and function to the processor 134 and memory 136 of the BMC 132 shown in FIG. 2A. In certain embodiments, the memory 144 can contain instructions executable by the processor 142 to cause the processor 142 to provide a sensing component 160, an analysis component 162, a control component 164, and a calculation component 166 interconnected with one other. Each component may comprise a computer-executable program, procedure, or routine which may have been originally written as source code in a conventional programming language.

The sensing component 160 can be configured to receive operations data 150 and converting the operations data 150 into a suitable input value. For example, the sensing component 160 may receive an instruction for performing an operation from the memory controller 114 (FIG. 2A) and convert the received operations data 150 into at least one of a read, write, erase, or other suitable types of operations to be performed on the volatile memory module 122 (FIG. 2A). In another example, the sensing component 160 can also be configured to receive one or more policies 119 from the memory controller 114, for example, as metadata associated or attached to data to be written into the volatile memory module 122. The policies 119 can then be stored in the memory 144. In further examples, the sensing component 160 can receive an input from the main processor 112 (FIG. 2A), the memory controller 114, or other components of the computing unit 104 (FIG. 2A), and convert the received operations data 150 as an instruction to initiate a persistence operation or other suitable operations.

The calculation component 166 may include routines configured to perform various types of calculations to facilitate operation of other components of the module controller 126. For example, the calculation component 166 can include routines for accumulating a count of write operations received from the sensing component 160. In other examples, the calculation component 166 can include linear regression, polynomial regression, interpolation, extrapolation, and/or other suitable subroutines. In further examples, the calculation component 166 can also include counters, timers, and/or other suitable routines.

The analysis component 162 can be configured to analyze the sensed and/or calculated parameters from the calculation component 166 or the sensing component 160 and determine whether certain data in the volatile memory module 122 (or blocks thereof) is to be copied and persisted in the non-volatile memory module 124. The determination can then be stored as records of log 154 in the memory 144. In certain embodiments, the analysis component 162 can indicate that data from the volatile memory module 122 (or blocks thereof) is to be persisted in response to determining that at least one data items in the volatile memory module 122 has been changed in a write operation. In other embodiments, the analysis component 162 can cause data in the volatile memory module 122 to be compared to the data in the non-volatile memory module 124. The analysis component 162 can then indicate persistence of some of the data in the volatile memory module 122 that is different than the data in the non-volatile memory module 124. The comparison can be by data block, data page, or the entire volatile memory module 122.

In further embodiments, the analysis component 162 can also be configured to indicate non-persistence or certain data in the volatile memory module 122 based on certain data patterns. For example, the analysis component 162 can indicate non-persistence of a block of data in response to determining the following:
The block of data all contains certain bit values (e.g., “0”);
The block of data contains certain lengths (e.g., 128 bits) of certain bit values (e.g., “0”); or
The block of data contains a certain number of repetition of bit values (e.g., “00001111” or “10101010”).
   In other examples, the analysis component 162 can utilize the calculation component 166 to calculate a hash value of the block of data. The analysis component 162 can then indicate persistence or non-persistence when the hash value is within certain ranges. In yet other examples, the analysis component 162 can utilize the calculation component 166 to calculate an entropy of the block of data. The analysis component 162 can then indicate persistence or non-persistence when the calculated entropy is greater than, less then, or within certain ranges. In further examples, the analysis component 162 can determine patterns of the block of data using statistical analysis or other suitable techniques. In yet further embodiments, the analysis component 162 can retrieve one or more records of policies 119 corresponding to the data from the memory 144 and determine whether the data is to be persisted based on the one or more policies 119.

The control component 164 can be configured to control selective persistence of data from the volatile memory module 122 to the non-volatile memory module 124. In certain embodiments, the control component 164 can transmit persistence commands 152, for example, to the non-volatile memory module 124 based on persistence or non-persistence indications received from the analysis component 162. In other embodiments, the control component 164 can also monitor and manage the persistence of certain data from the volatile memory module 122 to the non-volatile memory module 124.

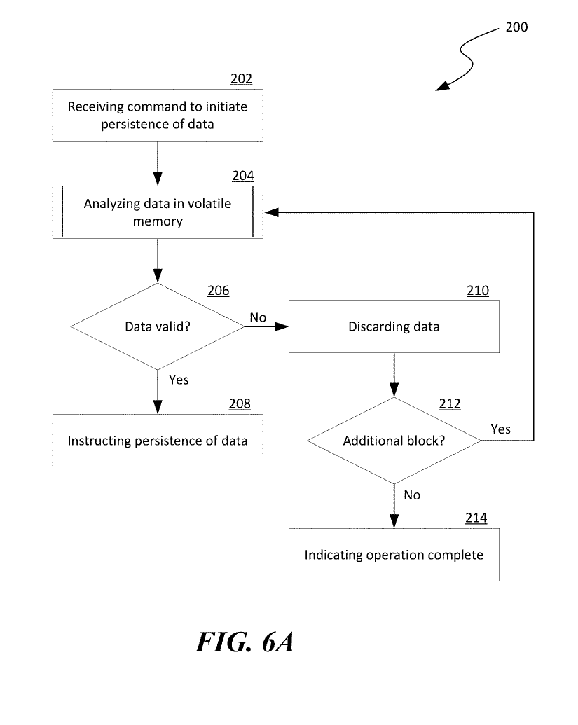

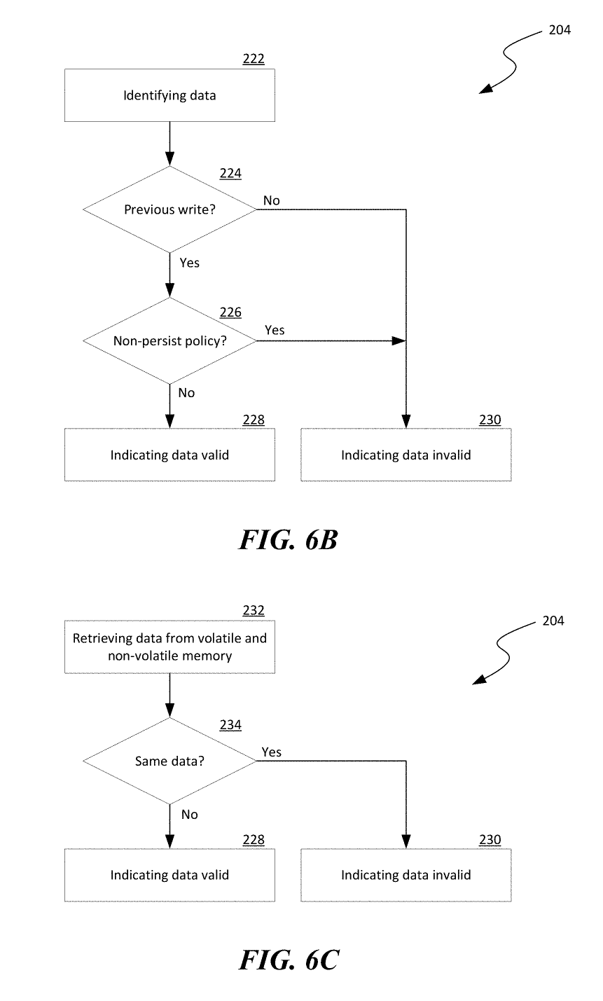

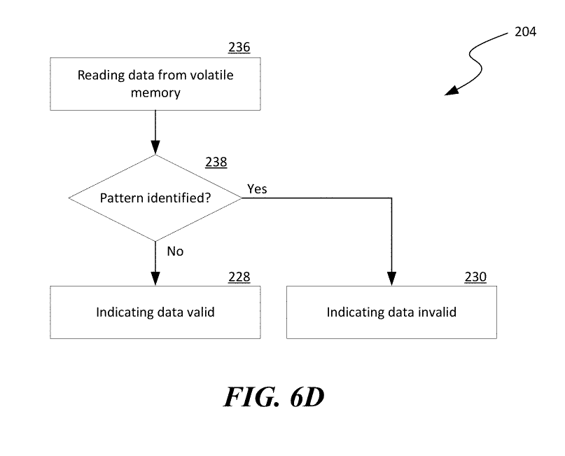

FIG. 6A is a flow diagram illustrating a process 200 for selective data persistence in accordance with embodiments of the present technology. Even though the process 200 is described below with reference to the computing system 100 in FIG. 1 and the computing unit 104 in FIGS. 2A-4C, several embodiments of the process 200 may also be used in other computer systems or devices.

As shown in FIG. 4, the process 200 can include receiving a command to initiate persistence of data from a volatile memory module 122 (FIG. 2A) to a non-volatile memory module 124 (FIG. 2A) in a hybrid memory device 120 (FIG. 2A) at stage 202. In one embodiment, the command can include a signal from the BMC 132 (FIG. 2A) applied on the input pin 127 (FIG. 2A). In another embodiment, the command can include a command transmitted from the memory controller 114 (FIG. 2A) to the hybrid memory device 120 via the data bus 109 (FIG. 2A). In further embodiments, the command can include other suitable signals from, for instance, the enclosure controller 105 of FIG. 1 or other suitable sources.

The process 200 can then include analyzing data in the volatile memory module 122 to determine whether at least a portion of the data in the volatile memory module 122 is valid data to be copied and persisted in the non-volatile memory module 124 at stage 204. As discussed above with reference to FIGS. 2A-5, various techniques can be used for such a determination. For example, the module controller 126 (FIG. 2A) can track whether data in the volatile memory module 122 or a block thereof has been changed in a write operation from the memory controller 114. In another example, data in the volatile memory module 122 and in the non-volatile memory module 124 can be compared. Data that does not exist in the non-volatile memory module 124 can then be declared to be valid data. In further examples, one or more patterns of the data in the volatile memory module 122 or blocks thereof can be determined and compared to preset patterns. Based on such comparison, the module controller 126 can then declare certain data to be valid or invalid. Additional examples of analyzing data are described in more detail below with reference to FIGS. 6B-6D.

In certain embodiments, multiple methods can be used to determine whether data in the volatile memory module 122 contains valid or invalid data. Such methods can be applied in various sequences. The process 200 can also prioritize the various methods. For example, a non-persistence policy can be allowed to force certain data to be considered invalid, even though the data was written to and contains different data than what exists in the corresponding non-volatile memory. In another example, each operation at stages 224 (FIG. 6B), 226 (FIG. 6B), and 234 (FIG. 6C) can be included in a single implementation with a suitable order of execution. In certain implementations, early interruption, early termination, or other suitable logical operation optimization techniques can also be applied. For example, a TRUE result from a set of operations that are logically OR'd together implies that the result would be TRUE, regardless of the results from the remaining operations. Similarly, a FALSE result from a set of operations that are logically AND'd together implies that the result would be FALSE, regardless of the results of the remaining operations. Accordingly, the other operations in the set need not be completed.

The process 200 can then include a decision stage 206 to determine whether data in the volatile memory module 122 or a block thereof is valid data. In response to determining that the data in the volatile memory module 122 or a block thereof is valid, the process 200 proceeds to stage 208 at which the module controller 126 can instruct, monitor, and/or manage persistence of the data from the volatile memory module 122 to the non-volatile memory module 124. In response to determining that the data in the volatile memory module 122 of a block thereof is invalid, the process 200 proceeds to discarding the data by not copying and persisting the data from the volatile memory module 122 to the non-volatile memory module 124 at stage 210.

The process 200 can then include another decision stage 212 to determine whether the volatile memory module 122 contains additional blocks. In response to determining that one or more additional blocks exist in the volatile memory module 122, the process 200 reverts to analyzing data in the one or more additional blocks at stage 204. In response to determining that no more blocks exist in the volatile memory module 122, the process 200 includes indicating, for example, to the BMC 132, that the initiated persistence operation is completed.

FIG. 6B is a flowchart illustrating example operations of analyzing data in the volatile memory module 122 of FIG. 2A in accordance with embodiments of the disclosed technology. As shown in FIG. 6B, the operations can include identifying the data at stage 222. In one embodiment, identifying the data can include identifying a physical or logical location of the data in the volatile memory module 122. In other embodiments, identifying the data can include identifying metadata, preamble, or other data associated with the data in the volatile memory module 122. The operations can then include a decision stage 224 to determine whether at least one previous write operation has been performed on the identified data. Write operations to the volatile memory module 122 or blocks thereof can be tracked using, for example, a single bit or other suitable logic values. In response to determining that there has been not even one write operation to the data, the operations include indicating that the data is invalid.

In response to determining that there has been at least one write operation performed on the identified data, the operations include another decision stage 226 to determine whether the identified data has an associated non-persist policy. In response to determining that there is an associated non-persist policy, the operations proceed to indicating data invalid at stage 230. In response to determining that there is no associated non-persist policy, the operations proceed to indicating the identified data to be valid at stage 228.

FIG. 6C is a flowchart illustrating additional example operations of analyzing data in the volatile memory module 122 of FIG. 2A in accordance with embodiments of the disclosed technology. As shown in FIG. 6C, the operations include retrieving data from both the volatile memory module 122 and the non-volatile memory module 124 at stage 232. The operations can then include a decision stage 234 to determine whether the data from the volatile memory module 122 is the same as or substantially similar to the data in the non-volatile memory module 124. In response to determining that the data is the same or substantially similar, the operations include indicating the data to be valid; otherwise, the operations include indicating the data to be invalid.

FIG. 6D is a flowchart illustrating further example operations of analyzing data in the volatile memory module 122 of FIG. 2A in accordance with embodiments of the disclosed technology. As shown in FIG. 6D, the operations include reading data from the volatile memory module 122. The operations can then include a decision stage 238 to determine whether a preset pattern of the data is identified. Various preset patterns can be used. Example patterns are described above with reference to FIG. 5. Based on the determined pattern, the operations can include indicating data to be valid at stage 228 or indicating data to be invalid at stage 230.

FIG. 7 illustrates one example of utilizing multiple tracking bits for tracking write operations in a volatile memory module 122 of a hybrid memory device 120 in a computing unit 104 of FIG. 1 in accordance with embodiments of the present technology. In the example shown in FIG. 7, the volatile memory module is logically divided into twelve memory blocks numbered 0-11 individually corresponding to a tracking bit 0-11. In other examples, the volatile memory module can be divided into other suitable number of memory blocks individually corresponding a tracking bit.

As shown in FIG. 7, during initialization at T₀, all the tracking bits 121 can be set to a value of “0.” The term initialization can refer to configuration that occurs during power-on, prior to any externally-requested writes to the hybrid memory device 120. The term initialization can also refer to the completion of a persist operation (e.g., following a loss of main power). During loading of an operating system on the computing unit 104 at T₁, memory blocks 0-3 can have data written to these memory blocks. As such, tracking bits 0-3 can be set to a value of “1.” During loading and/or execution of applications 1 and 2 at T₂, blocks 4-7 and 8-11 can have data written to these memory blocks. As such tracking bits 4-7 and 8-11 can be set to a value of “1.” At T₃, both applications 1 and 2 are terminated. However, tracking bits 4-7 and 8-11 still have a value of “1” because corresponding memory blocks 4-7 and 8-11 have each been written into.

In certain embodiments, the operating system or other suitable component of the computing unit 104 (e.g., one with knowledge of whether the memory blocks are in use) can transmit a message (e.g., an I²C command) to the module controller 126 (FIG. 2A) to indicate that one or more memory blocks in the volatile memory module 122 may be treated as containing invalid data. In response to the message, the module controller 126 can reset tracking bits 4-7 and 8-11 to a value of “0.” In other embodiments, a later write (not shown) may once again transition at least some of the tracking bits to a value of “1”. As such, at least some data from memory blocks 4-7 and 8-11 are not persisted to the non-volatile memory module 124 based on the message indicating these memory blocks can be treated as containing invalid data. In other embodiments, the module controller 126 can discard any data in memory blocks 4-7 and 8-11 in other suitable manners.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A hybrid memory device, comprising:
a volatile memory module configured to be accessible by a processor in a computing device as randomly addressable memory;
a non-volatile memory module; and
a module controller operatively coupled to the volatile memory module and the non-volatile memory module, the module controller having a processor and memory containing instructions executable by the processor to cause the processor to perform a process including:
receiving a signal to initiate data persistence from the volatile memory module to the non-volatile memory module;
determining whether the volatile memory module contains valid data;
in response to determining the volatile memory module contains valid data, causing the valid data from the volatile memory module to be copied to and persisted in the non-volatile memory module; and
in response to determining that the volatile memory module contains invalid data, allowing power to be removed from the hybrid memory device without copying the invalid data from the volatile memory module to the non-volatile memory module, thereby discarding the invalid data currently contained in the volatile memory module.

2. The hybrid memory device of claim 1 wherein determining whether the volatile memory module contains valid data includes determining whether at least one write operation has been performed to data in the volatile memory module since initialization.

3. The hybrid memory device of claim 1 wherein determining whether the volatile memory module contains valid data includes:
retrieving metadata representing one or more policies corresponding to data in the volatile memory module;
determining whether the one or more policies of the retrieved metadata contain a restriction on persisting the corresponding data; and
in response to determining that the one or more policies contain a restriction on persisting the corresponding data, indicating that the volatile memory module contains invalid data.

4. The hybrid memory device of claim 1 wherein determining whether the volatile memory module contains valid data includes:
retrieving metadata representing one or more policies corresponding to data in the volatile memory module;
determining whether the one or more policies of the retrieved metadata contain a restriction on persisting the corresponding data; and
in response to determining that the one or more policies do not contain a restriction on persisting the corresponding data, indicating that the volatile memory module contains valid data.

5. The hybrid memory device of claim 1 wherein determining whether the volatile memory module contains valid data includes:
comparing data currently contained in the volatile memory module to data currently contained in the non-volatile memory module; and
in response to determining that the data currently contained in the volatile memory module is the same as the data currently contained in the non-volatile memory module, indicating that the data currently in the volatile memory module contains invalid data.

6. The hybrid memory device of claim 1 wherein determining whether the volatile memory module contains valid data includes:
comparing the data currently contained in the volatile memory module to data currently contained in the non-volatile memory module; and
in response to determining that the data currently contained in the volatile memory module is substantially different than the data currently contained in the non-volatile memory module, indicating that the data currently in the volatile memory module contains valid data.

7. The hybrid memory device of claim 1 wherein determining whether the volatile memory module contains valid data includes:
determining a pattern of data currently in the volatile memory module;
comparing the determined pattern to a preset pattern; and
in response to determining that the determined pattern is the same as the preset pattern, indicating that the data currently in the volatile memory module contains invalid data.

8. The hybrid memory device of claim 1 wherein determining whether the volatile memory module contains valid data includes:
determining a pattern of the data currently in the volatile memory module;
comparing the determined pattern to a preset pattern; and
in response to determining that the determined pattern is different than the preset pattern, indicating that the data currently in the volatile memory module contains valid data.

9. A method of selective data persistence in a computing device having a main processor and a memory controller operatively coupled to a hybrid memory device via a data bus, the hybrid memory device having a volatile memory module, a non-volatile memory module, and a module controller operatively coupled to the volatile memory module and the non-volatile memory module, the method comprising:
receiving a command to initiate persistence of data currently contained in the volatile memory module to the non-volatile memory module;
determining whether the data currently contained in the volatile memory module contains valid data;
in response to determining that the data currently contained in the volatile memory module contains valid data, causing the valid data to be copied from the volatile memory module to the non-volatile memory module; and
in response to determining that the data currently contained in the volatile memory module contains invalid data, allowing power to be removed from the computing device without copying the invalid data from the volatile memory module to the non-volatile memory module, thereby discarding the invalid data currently contained in the volatile memory module.

10. The method of claim 9 wherein determining whether the data currently contained in the volatile memory module contains valid data includes determining whether at least one write operation has been performed to the data currently contained in the volatile memory module since initialization.

11. The method of claim 10, further comprising:
in response to determining that at least one write operation has been performed to the data currently contained in the volatile memory module since initialization, retrieving records representing one or more policies corresponding to the data currently contained in the volatile memory module;
determining whether the one or more policies contain a restriction on persisting the corresponding data; and
in response to determining that the one or more policies contain a restriction on persisting the corresponding data, indicating that the data currently in the volatile memory module contains invalid data even though at least one write operation has been performed since initialization to the volatile memory module.

12. The method of claim 10, further comprising:
in response to determining that at least one write operation has been performed to the data currently contained in the volatile memory module, retrieving records representing one or more policies corresponding to the data currently contained in the volatile memory module;
determining whether the one or more policies contain a restriction on persisting the corresponding data; and
in response to determining that the one or more policies do not contain a restriction on persisting the corresponding data, indicating that the data currently in the volatile memory module contains valid data.

13. The method of claim 9 wherein determining whether the data currently contained in the volatile memory module contains valid data includes:
comparing the data currently contained in the volatile memory module to data currently contained in the non-volatile memory module; and
in response to determining that the data currently contained in the volatile memory module is the same as the data currently contained in the non-volatile memory module, indicating that the data currently in the volatile memory module contains invalid data.

14. The method of claim 9 wherein determining whether the data currently contained in the volatile memory module contains valid data includes:
comparing the data currently contained in the volatile memory module to data currently contained in the non-volatile memory module; and
in response to determining that the data currently contained in the volatile memory module is substantially different than the data currently contained in the non-volatile memory module, indicating that the data currently in the volatile memory module contains valid data.

15. The method of claim 9 wherein determining whether the data currently contained in the volatile memory module contains valid data includes:
determining a pattern of the data currently in the volatile memory module;
comparing the determined pattern to a preset pattern; and
in response to determining that the determined pattern is the same as the preset pattern, indicating that the data currently in the volatile memory module contains invalid data.

16. The method of claim 9 wherein determining whether the data currently contained in the volatile memory module is valid data includes:
determining a pattern of the data currently in the volatile memory module;
comparing the determined pattern to a preset pattern; and
in response to determining that the determined pattern is different than the preset pattern, indicating that the data currently in the volatile memory module contains valid data.

17. The method of claim 9, further comprising:
in response to receiving the command to initiate persistence of data currently contained in the volatile memory module to the non-volatile memory module, retrieving records representing one or more policies corresponding to the data currently contained in the volatile memory module;
determining whether the one or more policies contain a restriction on persisting the corresponding data; and
in response to determining that the one or more policies contain a restriction on persisting the corresponding data, indicating that the data currently in the volatile memory module contains invalid data.

18. The method of claim 9 wherein:
the volatile memory module includes a first data block and a second data block respectively containing first data and second data;
determining whether the data currently contained in the volatile memory module contains valid data includes determining:
whether the first data currently contained in the first data block of the volatile memory module contains valid data; and
whether the second data currently contained in the second data block of volatile memory module contains valid data; and
in response to determining that the first data block contains valid data, causing the first data to be copied from the first data block of the volatile memory module to the non-volatile memory module; and
in response to determining that the second data currently contained in second data block of the volatile memory module contains invalid data, allowing power to be removed from the computing device without copying the second data from the volatile memory module to the non-volatile memory module, thereby discarding the second data currently contained in the second data block of the volatile memory module.

19. A method of selective data persistence in a computing device having a main processor and a memory controller operatively coupled to a hybrid memory device via a data bus, the hybrid memory device having a volatile memory module, a non-volatile memory module, and a module controller operatively coupled to the volatile memory module and the non-volatile memory module, the method comprising:
receiving an indication to initiate a data persistence operation from the volatile memory module to the non-volatile memory module, the volatile memory containing a set of data when the indication is received; and
in response to receiving the indication to initiate the data persistence operation,
selectively copying a first subset of the data in the volatile memory module to the non-volatile memory module, thereby persistently storing the first subset of the data in the non-volatile memory module; and
indicating the data persistence operation is completed without copying a second subset of the data from the volatile memory module to the non-volatile memory module, thereby allowing the second subset of the data to be discarded from the volatile memory module upon power removal from the hybrid memory device.

20. The method of claim 19, further comprising:
in response to receiving the indication to initiate the data persistence operation,
performing at least one of:
determining whether at least one write operation has been performed in the volatile memory module;
determining whether data currently in the volatile memory module includes metadata indicating that the data is not to be persisted;
determining whether the data currently in the volatile memory module is the same as data in the non-volatile memory module; or
determining whether the data currently in the volatile memory module has a data pattern that matches a preset pattern; and
indicating that the first subset of the data is to be persisted in response to determining at least one of (i) that at least one write operation has been performed in the volatile memory module, (ii) that the data currently in the volatile memory module does not include metadata indicating that the data is not to be persisted, (iii) that the data currently in the volatile memory module is not the same as the data in the non-volatile memory module, or (iv) the data currently in the volatile memory module has a data pattern that does not match the preset pattern; and
indicating that the second subset of the data is not to be persisted in response to determining one of (i) that at least one write operation has not been performed in the volatile memory module, (ii) that the data currently in the volatile memory module includes metadata indicating that the data is not to be persisted, (iii) that the data currently in the volatile memory module is the same as the data in the non-volatile memory module, or (iv) the data currently in the volatile memory module has a data pattern that matches the preset pattern.
